(19) United States
(12) Patent Application Publication
(10) Pub. No.: US 2012/0161498 A1
(43) Pub. Date: Jun. 28, 2012

(54) MAW-DirectDrives

(75) Inventor: Dana Allen Hansen, Torrance, CA (US)

(73) Assignee: Mr. Dana Allen Hansen, Torrance, CA (US)

(21) Appl. No.: 13/415,424

(22) Filed: Mar. 8, 2012

Related U.S. Application Data
(63) Continuation-in-part of application No. 12/386,047, filed on Apr. 13, 2009.
(60) Provisional application No. 61/124,179, filed on Apr. 15, 2008.

(51) Int. Cl. B60K 7/00

(52) U.S. Cl. 301/6.5

(57) ABSTRACT

MAW-DirectDrives are a mechanical direct drive mounting apparatus incorporating paired prefabricated frameless direct drive permanent magnets brushless motor stators as actuators. The stators mount on enhanced cooling stator mounting backs connected to a stationary sub-assembly mounting-plate that support vehicle suspensions on its rear. A drive-plate and spindle sub-assembly connected inside vehicle wheels fastens the two sub-assemblies and holds a cylindrical two-sided permanent magnets drive-rotor concentrically disposed between the stators and proximate to the stators' core peripheral surfaces to interact and actuate rotation about the stationary sub-assembly's cylindrical wheel-hub. The paired facing stators interacting with the drive-rotor create a complementary working relationship affording greater efficiency and power plus gains dual functionality by utilizing actuated rotation to generate electricity via the second stator for input back into the power supply reducing the vehicle's need of electrical power. Stationary sub-assembly mounted supplemental air brake units utilize lengthened spindles projecting out for brake-rotor operation.

### CROSS-REFERENCE TO RELATED APPLICATIONS

Applicant states that this application is a continuation-in-part of application Ser. No. 12/386,047, filed Apr. 13, 2009 which claims the benefit of U.S. Provisional Patent Application No. 61/124,179 filed Apr. 15, 2008 and that said applications are incorporated by reference herein in their entirety.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

1. Field of the Invention

The present invention also known as MAW-DirectDrives henceforth will be referenced by said term.

MAW-DirectDrives relate to a mechanical direct drive mounting apparatus that enables incorporating paired prefabricated frameless direct drive permanent magnets brushless motor stators as actuators, to create a dual functioning direct drive motor capable of actuating rotation of a connected object while firmly fastened to another.

MAW-DirectDrives are created to incorporate into transportation vehicle wheels and actuate rotation with greater power and efficiency while simultaneously during movement generate electricity via the second stator to input back into the vehicle's power supply and reduce the vehicle's need of electricity in addition to when the vehicle is stopped rely on a supplemental air brake for holding thus eliminate the use of electricity when stopped reducing further the electrical demand.

MAW-DirectDrives are created to have greater retrieval from regenerative braking plus eliminate heat build-up and energy loss associated with dynamic braking making dynamic breaking a viable form to bring a vehicle to stop thus not requiring friction based mechanical brakes during motion.

2. Description of Related Art

Present transportation technology since its inception has used power-plants that utilize numerous mechanical parts to produce torque to rotate a wheel coupled with assemblies and mechanical devices adding more mechanical parts to the total, all to process and make that torque useable and ready for transmission to the wheel(s) via even more assemblies and mechanical devices, all to propel a vehicle. With these systems the efficiency is degraded every time the power/torque encounters friction, alteration, a change in direction or delay and when compounded with the torque originating from a rapid small diameter, possessing characteristics that require extensive processing and the use of these assemblies and mechanical devices, the torque produced by these power-plants in the end has degraded significantly and made the vehicle inefficient.

Present Hybrid technology is attempting to reduce the number of parts associated with the drive-train and eliminate the losses associated with those parts, but the torque being produced is still originating from a rapid small diameter and requires that processing and transmission, ultimately making the vehicle inefficient.

There are a few companies like e-traction in the Netherlands producing vehicles (buses and delivery trucks) that utilize a direct drive format where the electrical motor connects directly to the wheel eliminating the losses associated with a centralized power production format and they also realize the value that diameter plays in the production of torque ultimately eliminating the need for gearing but they have limited their torque production ability and efficiency with their designs inability to grow in diameter.

All Electric, Hybrid and Direct Drive technologies today understand Electronic braking and its ability to stop a vehicle but do not utilize that because of heat build-up and efficiency loss while at the same time they do not fully utilize regenerative braking technology during the braking process to assist in decreasing the on-board demand for electrical storage or production. Modern vehicles do not take advantage of the kinetic energy that a vehicle possesses during travel as they do in braking, the energy potential for any vehicle is available to harness during the entire time of travel and one way to capture and harness that energy (kinetic) is to utilize the rotation of every wheel. With today's rail transportation format being the architect of Hybrid technology, they and commercial trucking still resort to a central/core power-plant, causing to rotate a limited number of wheels to pull a heavy load that on the most part is supported on its own wheels just bearing the load and offering no assistance/help.

Today's state of the art wind generation technology utilizes frameless permanent magnets direct drive alternators and modern large scale machinery uses frameless permanent magnets direct-drive BLDC motors which require no need for gearing or mechanical braking and both take advantage of larger diameters to increase power output, these two technologies united together within a unit connected to each wheel on transportation will efficiently and smoothly propel and stop any size vehicle and continually generate electricity during motion to increase the performance and further reduce the electrical demand.

### BRIEF SUMMARY OF THE INVENTION

MAW-DirectDrives offer a new opportunity to incorporate frameless direct drive technological goods on the market today into a mechanical direct drive mounting apparatus to create an ability to actuate and stop motion while at the same time utilize that motion to generate electricity to input back into the power supply thus reducing the requirement of storage or production needed to induce said motion.

MAW-DirectDrives incorporate two facing prefabricated frameless direct drive permanent magnets stators as actuators interacting with a cylindrical two-sided permanent magnets drive-rotor between said stators to induce rotation of said drive-rotor affixed to a drive-plate and spindle sub-assembly about a stationary sub-assembly's cylindrical wheel-hub projecting in from its mounting-plate supporting said stators on attached enhanced cooling stator mounting backs. They actuate and stop motion with more power while simultaneously generating electricity and connect directly inside transportation vehicle wheels and to their suspensions eliminating any need of inefficient central power-plant formats with all their associated mechanical devices.

MAW-DirectDrives configured state gain redundancy through the incorporation of the second stator and increase the output efficiency of each stator by working upon each other in a manner that becomes complementary.

Vehicles incorporating MAW-DirectDrives with a custom air brake utilize compressed air storage when idle and only use power to actuate motion.

MAW-DirectDrives harness the kinetic energy a vehicle produces during motion which until now has been an untapped reservoir of energy.

MAW-DirectDrives use a larger surface area of magnets requiring less power per square inch in association to power production, dynamic and regenerative braking making those formats much more efficient.

MAW-DirectDrives use larger diameter frameless stators which take advantage of magnetic properties to achieve greater efficiency and output, which is attributed to the properties of magnetic flux being that magnetic flux attracts and repel off the surface at right angles the smoother parallel relationship as diameter increases achieves greater utilization due to less scattering of the magnetic flux that curvature inflicts.

MAW-DirectDrives configuration is uncomplicated and simple to manufacture and assemble plus easy to employ into transportation vehicles thus reducing cost in addition they enable a straightforward integration of radar, GPS communication and guidance technology via computer control without the need for alteration or modification for its accommodation.

MAW-DirectDrives power potential is proportional to the overall surface area of magnets incorporated plus the wind utilized within the stators in addition they can incorporate the most powerful winds producing the highest ratio of power to size that also produce proportionately higher heat when utilizing embodiments that use compressed air and/or liquid to cool said stators.

Utilizing MAW-DirectDrives on every wheel of mass transit, rail and commercial trucking make each wheel contribute during all motion and compounds that input during breaking operations utilizing regenerative braking principles. The overall input generated by motion and braking will benefit greatly the efficiency of all vehicles and reduce the vehicle's demand for onboard power production or storage.

Additional objects, features and advantages of MAW-DirectDrives will become apparent from the following detailed description of preferred embodiments when read with reference to the accompanying drawings.

### BRIEF DESCRIPTION OF THE SEVERAL VIEWS OF THE DRAWING

In order that the advantages of MAW-DirectDrives will be understood, a more particular description of MAW-DirectDrives briefly described above will be rendered by reference to specific embodiments illustrated in the appended drawings. Understanding that these drawings depict only typical embodiments of MAW-DirectDrives and are not therefore to be considered limited of its scope, MAW-DirectDrives will be described and explained with additional specificity and detail through the use of the accompanying drawings. The term Figure as related to FIG. 1 thru FIG. 22 used in the following drawings henceforth will be referenced in the abbreviated form Fig . . . .

FIG. 1 is a cross-sectional view of a compressed air cooled MAW-DirectDrives unit incorporated with a custom air brake plus two-piece outer housing seal and pressure vent and attached inside a wheel's rim.

FIG. 2 is an exterior top view of a MAW-DirectDrives drive-plate and spindle sub-assembly.

FIG. 3 is an exterior top view of a MAW-DirectDrives drive-plate and spindle sub-assembly configured to incorporate the custom air brake.

FIG. 4 is an exterior rear view of a MAW-DirectDrives drive-plate and spindle sub-assembly.

FIG. 5 is an exterior rear view of a MAW-DirectDrives drive-plate and spindle sub-assembly with attached two-sided permanent magnets drive-rotor cylinder.

FIG. 6 is an exterior side view of MAW-DirectDrives enhanced cooling stator mounting back for the outer stator.

FIG. 7 is an exterior side view of MAW-DirectDrives enhanced cooling stator mounting back for the inner stator.

FIG. 8 is an exterior rear view of MAW-DirectDrives enhanced cooling stator mounting back for the outer stator.

FIG. 9 is an exterior inside view of MAW-DirectDrives stationary mounting-plate and cylindrical wheel-hub.

FIG. 10 is an exterior inside view of MAW-DirectDrives stationary mounting-plate and cylindrical wheel-hub configured enclosed with an outer stationary encasement wall for compressed air cooling.

FIG. 11 is an exterior inside view of MAW-DirectDrives stationary mounting-plate and cylindrical wheel-hub configured enclosed with an outer stationary encasement wall for liquid and compressed air cooling.

FIG. 12 is a cross-sectional view of a basic convection cooled MAW-DirectDrives unit.

FIG. 13 is an exterior side view of FIG. 12

FIG. 14 is a cross-sectional view of a convection cooled MAW-DirectDrives unit with attached two-piece outer housing seal and pressure vent component.

FIG. 15 is an exterior side view of FIG. 14.

FIG. 16 is a cross-sectional view of a liquid and compressed air cooled MAW-DirectDrives unit with attached two-piece outer housing seal and pressure vent component.

FIG. 17 is an exterior side view of FIG. 16.

FIG. 18 is a cross-sectional view of a compressed air cooled MAW-DirectDrives unit with attached two-piece outer housing seal and pressure vent component plus configured with a custom air brake.

FIG. 19 is an exterior side view of FIG. 18.

FIG. 20 is a close-up cross-sectional view of a MAW-DirectDrives custom air brake.

FIG. 21 is an exterior inside view of a brake rotor for a MAW-DirectDrives custom air brake.

FIG. 22 is an exterior end view of a MAW-DirectDrives spindle configured for a custom air brake.

### DETAILED DESCRIPTION OF THE INVENTION

Before the various embodiments of MAW-DirectDrives are explained in detail, it is to be understood that MAW-DirectDrives are not limited in its application to the details of construction and the arrangements of components set forth in the following description or illustrated in the drawings. MAW-DirectDrives are capable of other embodiments and of being practiced or of being carried out in various ways. Also, it is to be understood that phraseology and terminology used herein with reference to device or element orientation (such as, for example, terms like “front”, “back”, “up”, “down”, “top”, “bottom”, and the like) are only used to simplify description of MAW-DirectDrives, and do not alone indicate or imply that the device or element referred to must have a particular orientation. In addition, terms such as “first”, “second”, and “third” are used herein and in the appended claims for purposes of description and are not intended to indicate or imply relative importance or significance. Furthermore, any dimensions recited or called out herein are for exemplary purposes only and are not meant to limit the scope of MAW-DirectDrives in any way unless so recited in the claims.

The following is a list of the reference numbers and their associated component or element used in the drawings and the detailed specification to identify the components and elements comprising the preferred embodiments of MAW-DirectDrives; all like components and elements are indicated with the same numeric designation.

| Component/ | |
|---|---|
| element No.: | Description of Component/element: |
| 1 | Drive-plate and spindle sub-assembly |
| 1.1 | Drive-plate element of component No. 1 |
| 1.2 | Spindle element of component No. 1 |
| 2 | Outer Radial shaft seal |
| 2.1 | Boss behind drive-plate for outer radial shaft seal |
| 2.2 | Counter bore in wheel-hub for outer radial shaft seal |
| 3 | Outer taper roller bearing |
| 3.1 | Spindle land behind boss for outer taper roller bearing |
| 3.2 | Front wheel-hub ID for outer taper roller bearing |
| 4 | Inner taper roller bearing |
| 4.1 | Spindle land for inner taper roller bearing |
| 4.2 | Rear wheel-hub ID for inner taper roller bearing |
| 4.3 | Spindle threads forward position for brake incorporation |
| 5 | Custom spanner lock nut and inner radial seal ride |
| 5.1 | Spindle threaded for custom spanner lock nut |
| 6 | Inner Radial shaft seal |
| 7 | Spacing washer plus needed shim washers |
| 7.1 | Spindle termination OD |
| 7.2 | Spindle termination OD configured for brake |
| 8 | XAN Series external retaining ring |
| 8.1 | Groove for external retaining ring |
| 9 | Two-sided permanent magnets drive-rotor cylinder |
| 9.1 | Two-sided drive-rotor cylinder body |
| 10 | Screws for drive-rotor attachment to drive-plate |
| 10.1 | Counter bored through holes in drive-plate |
| 10.2 | Threaded holes in drive-rotor |
| 11 | Hardened location pins |
| 11.1 | Drive-plate press fit bored holes for location pins |
| 11.2 | Drive-rotor location fit bored holes for location pins |
| 12 | Drive-rotor inner Neodymium magnet Arc-Segments |
| 13 | Drive-rotor outer Neodymium magnet Arc-Segments |
| 14 | Drive-rotor Neodymium magnet discs |
| 15 | Stationary sub-assembly (wheel-hub & mounting-plate) |
| 15.1 | Wheel-hub element of component No. 15 |
| 15.2 | Mounting-plate element of component No. 15 |
| 16 | Screws for outer stator attachment |
| 16.1 | Counter bored through holes in mounting plate |
| 16.2 | Threaded holes in outer stator mounting back |
| 17 | Outer stator enhanced cooling stator mounting back |
| 18 | Cooling ribs circumnavigating stator mounting back |
| 19 | Outer stator |
| 20 | Screws for inner stator attachment |
| 20.1 | Counter bored through holes in mounting plate |
| 20.2 | Threaded holes in inner stator mounting back |
| 21 | Inner stator enhanced cooling stator mounting back |
| 22 | Cooling ribs encircling stator mounting back |
| 23 | Inner stator |
| 24 | Molex style Shielded I/O connector for the stators |
| 24.1 | Mounting plate accommodation for I/O connector |
| 25 | Hall-effects, digital speed and direction sensor |
| 25.1 | Threaded through hole for Hall-effects sensor |
| 26 | NTC type Thermistor thermal sensor |
| 26.1 | Threaded through hole for thermal sensor |
| 27 | Two-piece outer housing seal and pressure vent |
| 28 | Screws for outer housing seal attachment |
| 28.1 | Through holes in outer housing seal |
| 28.2 | Threaded holes in outer stator mounting back |
| 28.3 | Threaded holes in outer stationary encasement wall |
| 29 | Outer stationary encasement wall |
| 30 | Encasement wall outer stator air cooling chamber |
| 30.1 | Encasement wall outer stator liquid cooling chamber |
| 31 | Wheel-hub OD inner stator air cooling chamber |
| 31.1 | Wheel-hub OD inner stator liquid cooling chamber |
| 32 | Outer stator mounting back O-ring |
| 32.1 | Groove for outer stator mounting back O-ring |
| 33 | Inner stator mounting back O-ring |
| 33.1 | Groove for inner stator mounting back O-ring |
| 34 | Central compressed air inlet connector |
| 34.1 | Threaded through hole for central air inlet connector |
| 35 | Encasement wall coolant inlet connector |
| 35.1 | Threaded hole into encasement wall base |
| 35.2 | Encasement wall coolant outlet connector |
| 35.3 | Threaded hole into encasement wall base |
| 36 | Wheel-hub OD coolant inlet connector |
| 36.1 | Threaded hole into wheel-hub OD base |
| 36.2 | Wheel-hub OD coolant outlet connector |
| 36.3 | Threaded hole into wheel-hub OD base |
| 37 | Encasement wall coolant inlet hole |
| 37.1 | Encasement wall coolant outlet hole |
| 38 | Wheel-hub OD coolant inlet hole |
| 38.1 | Wheel-hub OD coolant outlet hole |
| 39 | Outer stator mounting back compressed air exit holes |
| 40 | Inner stator mounting back compressed air exit holes |
| 41 | Longitudinal concave grooves for brake-rotor operation |
| 42 | Die spring for brake-rotor disengagement |
| 42.1 | Bored hole into spindle |
| 43 | Custom air brake housing |
| 44 | Screws for brake housing attachment |
| 44.1 | Through holes in brake rotor housing |
| 44.2 | Threaded holes in mounting plate |
| 45 | Hardened location pins |
| 45.1 | Brake housing location fit bored holes for location pins |
| 45.2 | Mounting plate press fit bored holes for location pins |
| 46 | Hardened press fit bushing |
| 46.1 | Brake housing press fit bored hole for bushing |
| 47 | Brake housing air inlet connector |
| 47.1 | Threaded through hole for brake air inlet connector |
| 48 | Brake cylinder plunger |
| 49 | Sealed taper roller thrust bearing |
| 49.1 | Counter bored hole into brake rotor |
| 50 | Brake rotor |
| 51 | Carbon fiber reinforced ceramic brake rotor insert |
| 52 | Carbon Kevlar annular brake pad |
| 53 | Metal brake pad backing ring |
| 54 | Hardened location pins |
| 54.1 | Backing ring location fit bored holes for location pins |
| 54.2 | Mounting plate press fit bored holes for location pins |
| 55 | Hardened metal balls |
| 56 | NAN Series internal retaining ring |
| 56.1 | Groove for internal retaining ring |
| 57 | Bored and bottom reamed holes for hardened metal balls |
| 58 | Brake rotor boss OD |
| 59 | Counter bore in brake rotor boss |
| 60 | Bored and bottom reamed hole in brake rotor boss |
| 61 | Wheel rim |
| 62 | Flathead screws for wheel rim attachment |
| 62.1 | Threaded through holes into drive plate |
| 63 | Press-in dust cap |

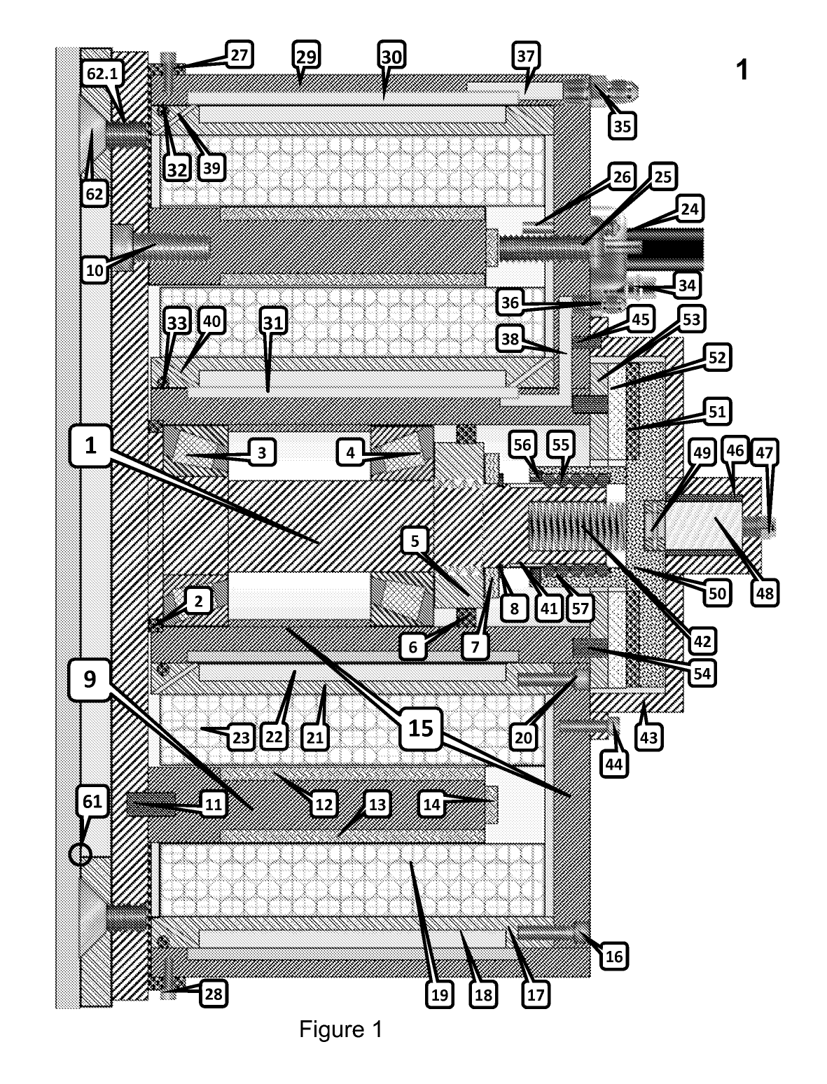

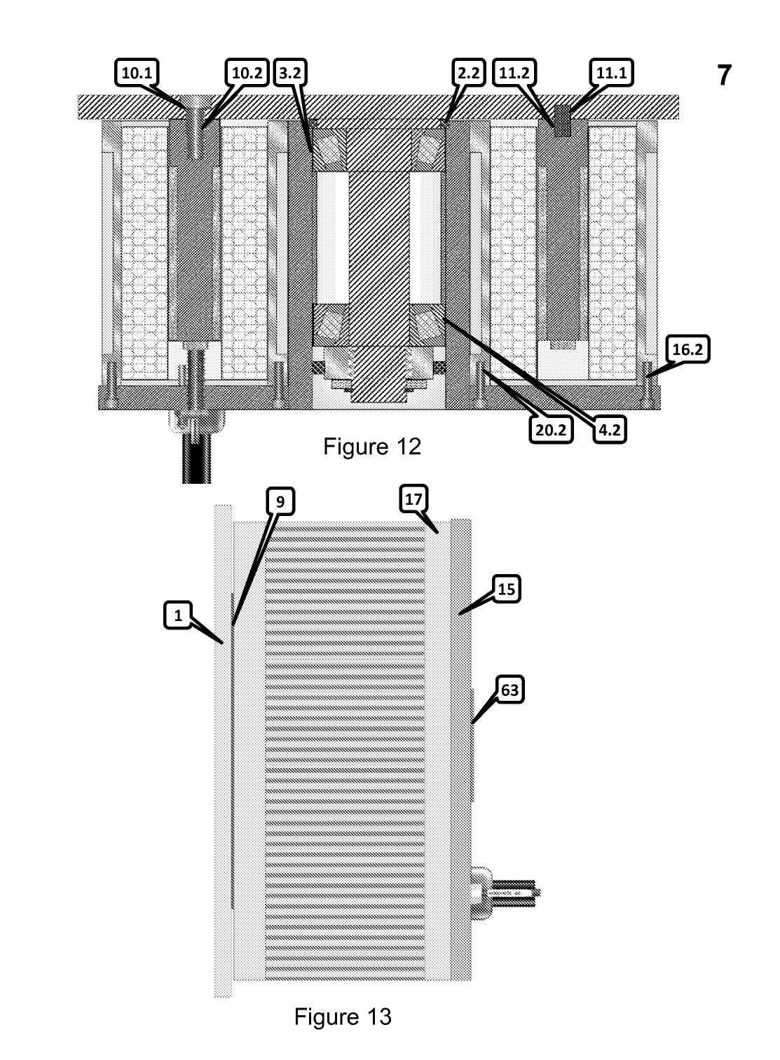

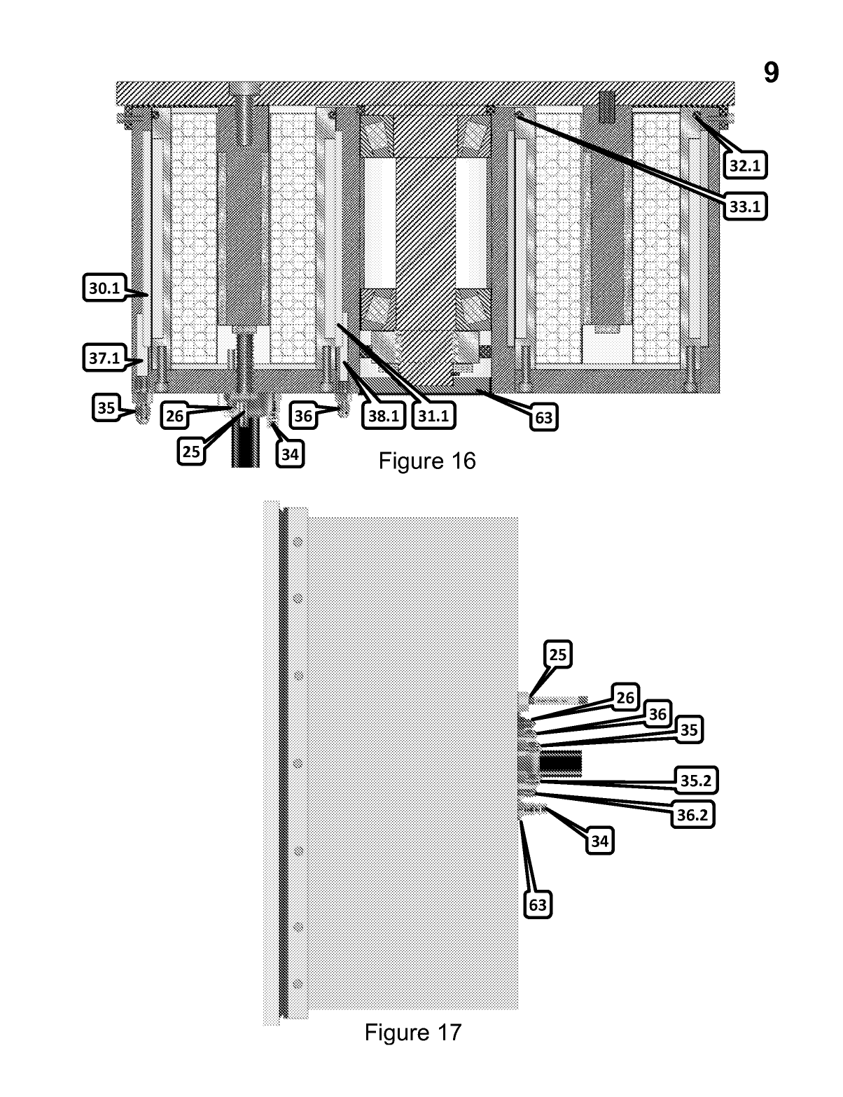

MAW-DirectDrives create a newfound method and system to attain a dual function direct drive motor capable of actuating motion with tremendous torque and utilize the rotation to directly generate electricity to feed back into the power reserve to reduce the requirement of onboard storage or production of electricity needed for the operation of a vehicle or object. The majority of like components and their elements comprising the four embodiments illustrated in FIGS. 12, 14, 16 and 18 are denoted in FIG. 1. Those and other components and elements have been itemized in the aforementioned list Ref. [0048].

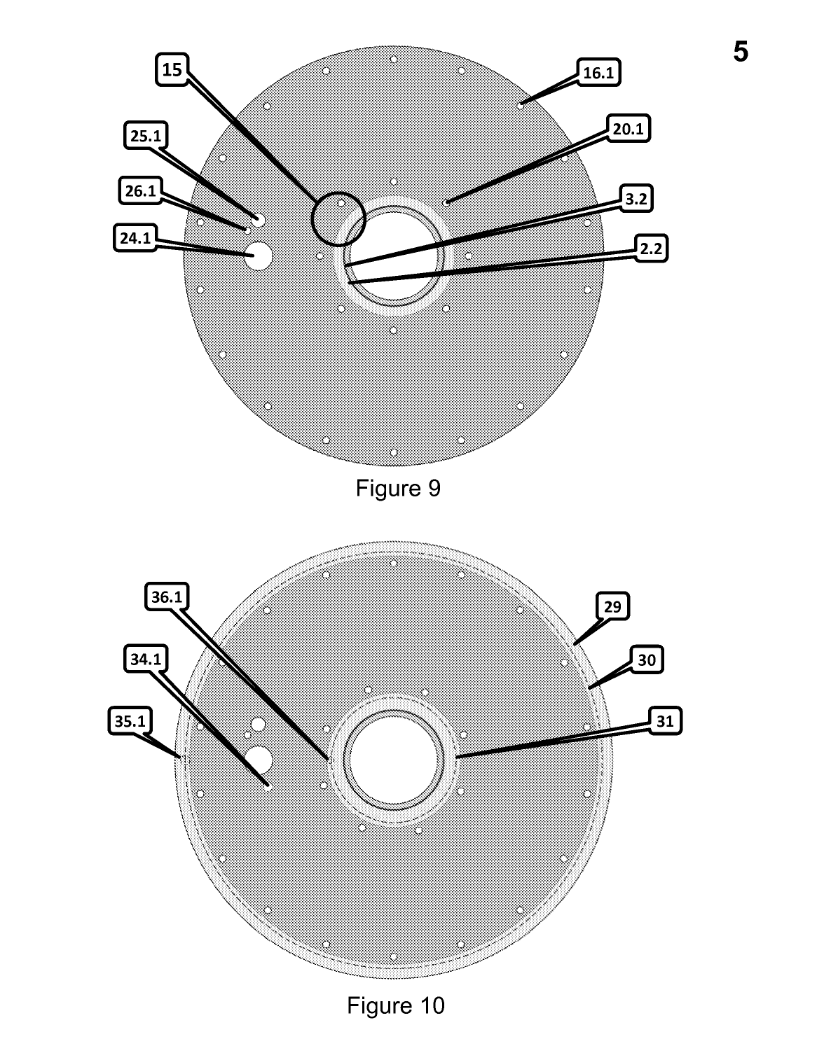

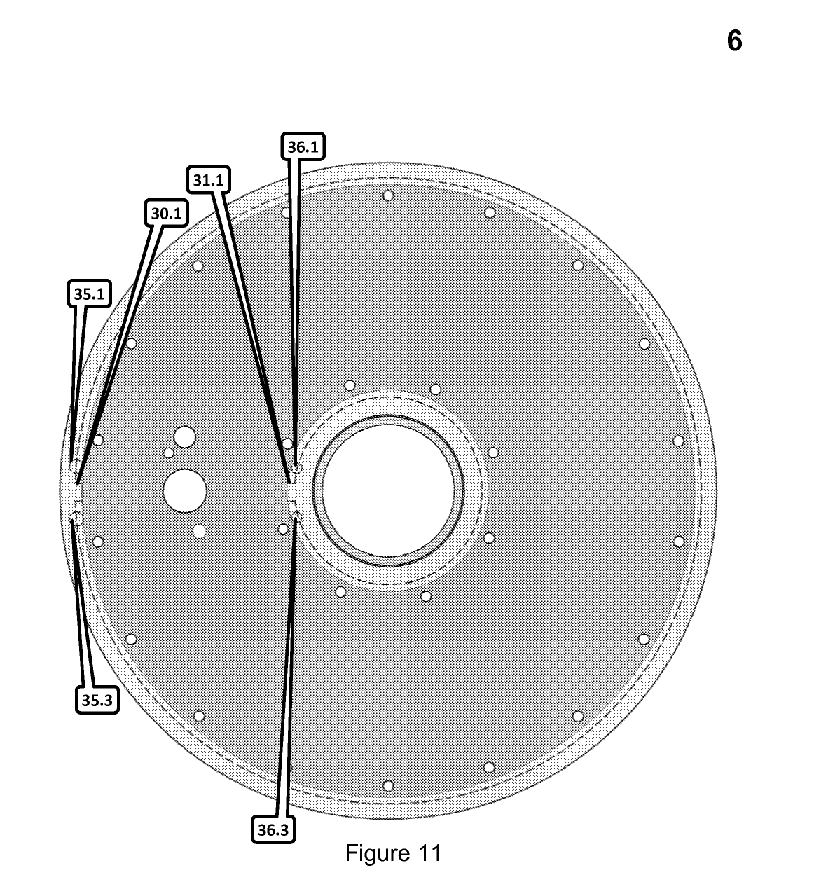

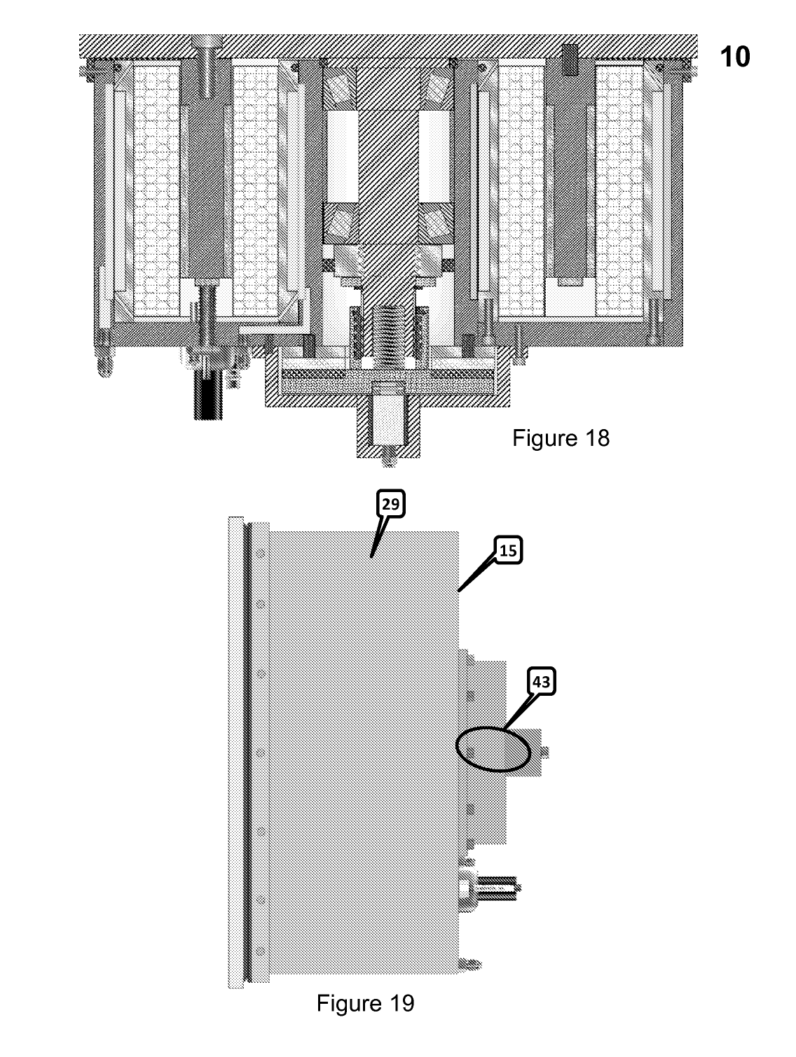

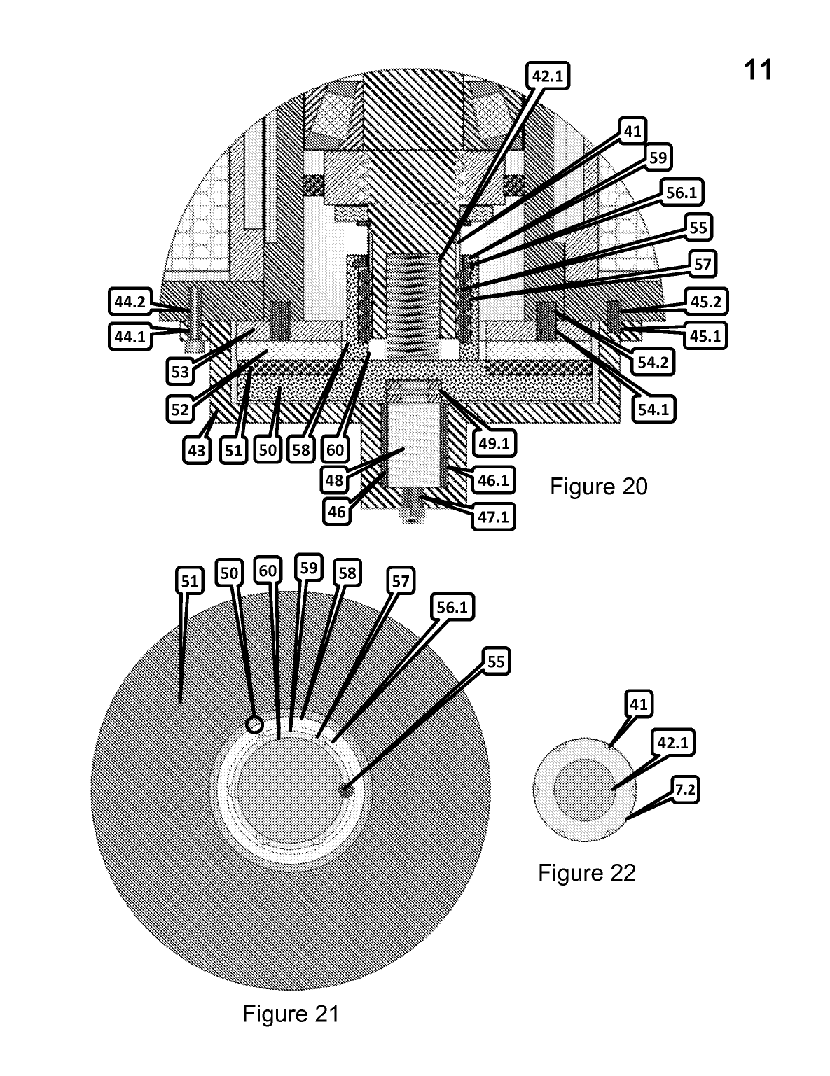

MAW-DirectDrives incorporate prefabricated frameless direct drive permanent magnets brushless motor stators 19 and 23 that are available today and orient them to complement each other when interacting with a MAW-DirectDrives cylindrical two-sided permanent magnets drive-rotor 9. The stators are mounted on enhanced cooling stator mounting backs 17 and 21 that connect to a stationary sub-assembly 15 comprising a wheel-hub 15.1 and mounting plate 15.2 using machine screws 16 and 20. The basic stationary sub-assembly 15 does not utilize an outer stationary encasement wall 29 thus relying on convection cooling to maintain stator operating temperature. The two-sided permanent magnets drive-rotor cylinder 9 connects to the drive-plate element 1.1 of a drive-plate and spindle sub-assembly 1 using machine screws 10 and utilizing location pins 11 for accurate positioning. The spindle element 1.2 of the drive-plate and spindle sub-assembly 1 projects back and is machined to accommodate an outer radial shaft seal 2, outer taper roller bearing 3, inner taper roller bearing 4, custom spanner lock nut and inner radial seal ride 5, spacing washer plus needed shim washers 7, XAN series external retaining ring 8, and when incorporating a custom air brake FIGS. 20, 21 and 22 longitudinal concave grooves 41 and a bored hole 42.1 into the spindle termination OD 7.2. To join and lock the two sub-assemblies together the spindle 1.2 traverses up through the wheel-hub 15.1 and the custom spanner lock nut 5 secures both sub-assemblies together and the spacing washer with needed shims 7 fill the gap between the lock-nut 5 and external retaining ring 8 to maintain the correct tolerance. For monitoring internal temperature of the unit a NTC type thermistor thermal sensor 26 is used and for monitoring speed and direction a Hall-effects, digital speed and direction sensor 25 is used and grouped in a cluster FIG. 9 in the vicinity of the stators I/O connector 24. Embodiments for units subjected to the elements of nature and/or the road utilize a two-piece outer housing seal 27 Ref. FIGS. 1, 14, 16 and 18. Embodiments to enhance cooling capacity utilizing compressed air for cooling FIGS. 1, 10, 18 and 19 can incorporate stator winds that produce greater output for a given size. The air cooled version's FIGS. 18 and 19 stationary sub-assembly 15 is outfitted with an outer stationary encasement wall 29 and both internal surfaces have cooling chambers cast in 30 and 31. The enhanced cooling stator mounting back created for the stators on the convection cooled units 17 and 21 incorporate O-rings 32 and 33 plus angled air circulation holes 39 and 40 that direct the controlled high pressure input entering at the stator's back and vent that air into the central cavity which travels through the interior forcing the now heated air out behind the two-piece outer housing seal and pressure vent 27 located at the outer front perimeter of the housing which also diminishes the friction the seal undergoes in operation. For units with even greater enhanced cooling capacity to incorporate the most powerful winds on the market today which also produce the most heat they utilize liquid and compressed air FIGS. 11, 16 and 17. The liquid and air cooled version utilizes the same enhanced cooling stator mounting back as the air cooled version but without the angled air circulation holes plus the same stationary sub-assembly casting as the air cooled version with one exception the addition of a partition wall going from front to back in both internal cooling chambers full depth and flush with the surface 30.1 and 31.1 FIG. 11. Each cooling chamber has an input line on one side of the partition 35.1 and 36.1 plus an output line on the other side 35.3 and 36.3 positioned across from one-another to create a favorable cluster of input/output lines and connectors FIG. 11. For units requiring a supplemental braking format for parking or emergency an embodiment utilizing a custom air brake FIGS. 1, 3, 18, 19, 20, 21 and 22 is used. The custom air brake designed for MAW-DirectDrives requires repositioning the rear components (inner taper roller bearing 4, locking spanner nut 5 with space and shim washers 7 plus external retaining ring 8) forward maintaining their same relationship 4.3 FIG. 3 plus extending the length of the spindle 7.2 enough to facilitate the travel of the brake rotor. The spindle's end is configured to accept the ride of the brake rotor using a ball spline format of travel to reduce friction plus increase efficiency by milling longitudinal concave grooves 41 from the spindle's end forward toward the retaining ring into the spindle OD which correlate with the brake rotor's bored and bottom reamed holes 57 filled with hardened metal balls 55 and then boring the end of the spindle 42.1 to facilitate a die/compression spring 42. The rotating brake rotor 50 is actuated in proportion to the input pressure 47 and otherwise kept disengaged by the die spring incorporated into the spindle's end and travels on the hardened metal balls 55 positioned in the bored and bottom reamed holes locking the parts together. The stationary brake pad 52 is supported by its metal mounting back 53 which is held in place on hardened location pins 54 and possesses a carbon fiber reinforced ceramic braking surface 52 to react to the carbon Kevlar brake surface 51 on the brake rotor 50. The brake housing 43 incorporates a central air-cylinder 46 with its brake cylinder plunger 48 riding on a sealed taper roller thrust bearing 49 set into the brake rotor 49.1 and is positioned on location pins 54 set into the stationary power assembly's rear face 54.2 plus secured by screws 44.

The abovementioned synopsis Ref. [0050] referenced the embodiments of MAW-DirectDrives detailed and illustrated for understanding. A more comprehensive detailing of said referenced embodiments of MAW-DirectDrives is forthcoming within this section.

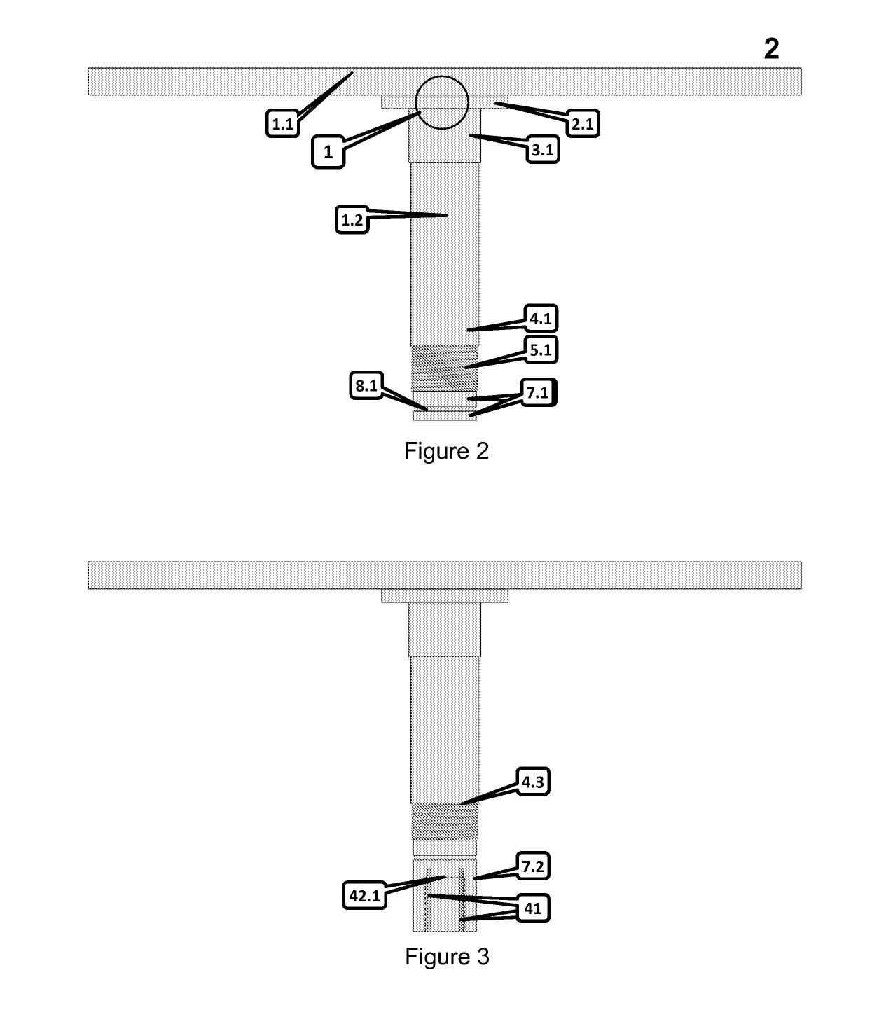

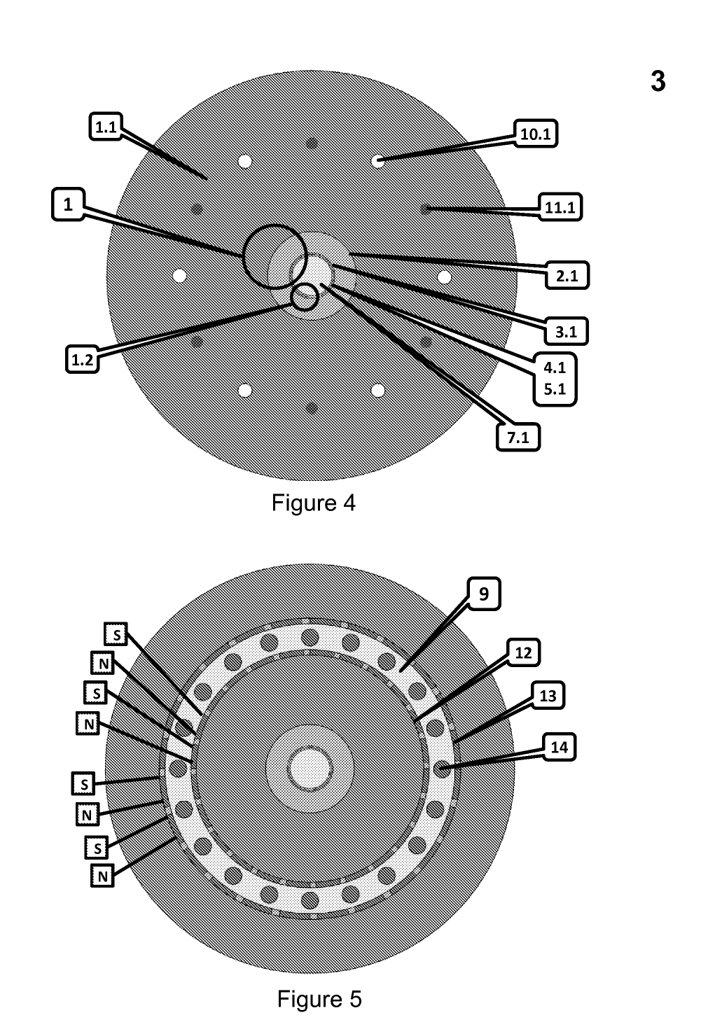

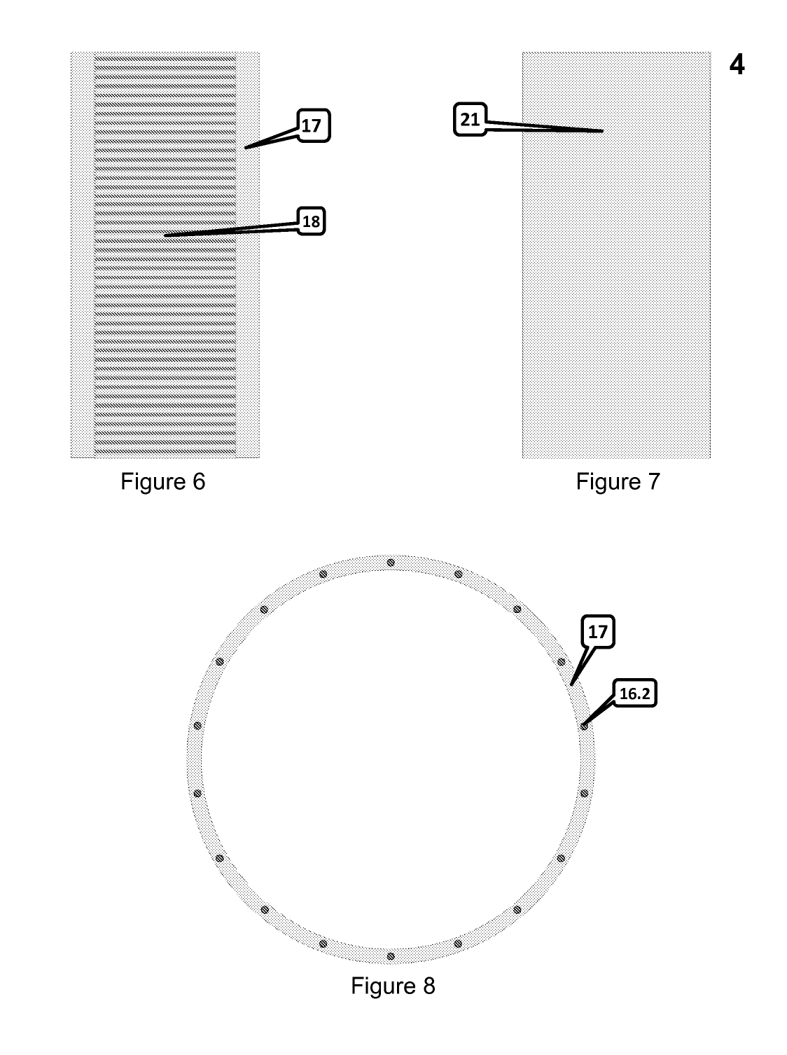

A MAW-DirectDrives drive-plate and spindle sub-assembly 1 is a casting made of 4340 alloy steel conforming to ASTM A320 standards. Rough casting dimensions are set to require at least 0.125″ of material to be machined off all surfaces and the shaft dimension should be set to 0.125″ larger than the outer bearing land 3. All surfaces are machined true to maintain concentricity and perpendicularity to the stationary sub-assembly 15. The circular boss 2.1 bears the ride of the outer radial shaft seal 2 and the surface maintains a 32μ finish. The spindle 1.2 behind the boss has two riding surfaces, the first 3.1 accommodates the outer taper roller bearing 3 following with one slightly reduced in diameter 4.1 and set back a distance to accommodate the inner taper roller bearing 4, before the rear of the outer taper roller bearing the land is threaded with Unified Screw Threads 5.1 then steps down to the spindle termination OD 7.1. The spindle termination OD is slightly smaller than the bottom of the threads to maintain structural stability and grooved 8.1 to accommodate the external retaining ring 8 working in conjunction with one thick spacing washer plus the necessary amount of shim washers 7 to completely fill the gap between the external retaining ring 8 and the tightened and torqued custom spanner lock nut 5 that joins the two assemblies together. The custom spanner lock nut OD bears the ride of the inner radial shaft seal and maintains a 32μ finish. The drive-plate and spindle sub-assembly 1 on units without supplemental braking FIGS. 2, 12, 14 and 16 terminate within the unit's housing leaving enough clearance for the pressed in dust cap 63 allowing the spindle's length to extend as far as possible for stiffness. The drive-plate and spindle sub-assembly on units utilizing the custom air brake FIG. 20 require repositioning the rear components (inner taper roller bearing, custom spanner lock nut with space and shim washers plus external retaining ring) forward 1.250″ keeping their relationship the same 4.3 and extending the length of the spindle 7.2 enough to facilitate the travel of the brake rotor 50. The spindle end 42.1 FIG. 22 is bored to facilitate the die spring 42 and requires milling six longitudinal concave grooves 41 into the OD starting from the spindle's end and going forward just shy of the external retaining ring. The depth and the radius of the longitudinal concave grooves coordinate and correlate with the diameter and positioning of the hardened metal balls used within the brake-rotor's ball spline format FIGS. 20 and 21. The rear face of the drive-plate 1.1 is the initiation point to institute machining procedures and precisely dial indicate into the spindle ID to maintain concentricity and perpendicularity to the spindle. For positioning of the two-sided permanent magnets drive-rotor 9, all location holes 11.1 bearing location pins 11 are bored to proper depth having flat bottoms and all mounting holes 10.1 mating to threaded holes in the drive-rotor 10.2 are through drilled then afterwards counter-bored to proper depth from the front face of the drive-plate 1.1, all holes will be equally spaced and located on the median diameter of the drive-rotor 9. For dimensional understanding the casting specifications for the drive-plate and spindle sub-assembly utilizing the custom air brake will be detailed. The rough casting is 20.000″OD±0.050″×1.000″W±0.050″ disc with a 4.000″OD±,050″×0.313″W±0.050″ boss on center with a spindle 2.250″OD±,050″×9.250″W±0.050″. The finish machining specifications maintain a 64μ finish unless otherwise noted and are: 19.750″OD±0.010×0.750″W±0.005″ disc with a 3.898″OD±0.002×0.338″W±0.005″ boss with a 32μ finish stepping down to a 2.000″OD±0.001″×1.500″W±0.063″ outer bearing land then reducing to a 1.875″OD±0.001″ inner bearing land with 1.250″W of 1.875″-12(UN) threads terminating 6.963″±0.005″ from the drive-plate rear face then stepping down to 1.748″OD±0.002 that ends 9.484″±0.010″ from the drive-plate rear face. Located 7.375″±0.005″ from the drive-plate rear face is a groove 1.670″OD×0.065″W±0.002″ for the external retaining ring. To accommodate the brake a 1.031″dia.hole×1.500″±0.010″deep is bored into the spindle and 6 longitudinal concave grooves 0.125″R machined in 0.065″±0.002″deep going forward 1.750″±0.010″ from the end.

The custom spanner lock nut and inner radial seal ride 5 is made of Grade C3 steel conforming to ASTM A563 standards. The finished machining specifications are a 3.465″OD±0.002″ with a 32μ finish×1.875″-12(UN) threaded ID×1.000″W±0.005″. Located on the face are four 0.188″OD holes×0.250″D located on a 2.688″BC spaced 90° on ¢.

MAW-DirectDrives' two-sided drive-rotor cylinder body 9.1 is a casting made of 410 stainless steel conforming to ASTM A176 standards. Rough casting dimensions are set to require at least 0.125″ of material to be machined off all surfaces. All surfaces are machined true to maintain concentricity and perpendicularity to the drive-plate and spindle sub-assembly 1. The unit's load bearing characteristics upon the casting determine the wall thickness of the drive-rotor's body between the rare earth permanent magnet arc-segments 12 and 13 comprising the two-sided drive-rotor then step-out in both directions 0.039″/1 millimeter less than the thickness of the individual magnet arc-segments and continue through to the drive-plate 1.1. The finished length is equal to the distance from the stator's innermost working point to the magnets to the drive-plate rear face. The drive-rotor body's median diameter represents the bolt circle all location holes 11.2 and threaded mounting holed 10.2 are machined on. Threaded mounting holes utilize Unified National Fine screw threads to a minimum depth of 1.000″. The drive-rotor end between the inner and outer magnet arc-segments secure by bonding neodymium disc magnets 14 equally spaced on center and sized to create a 50% duty cycle with the Hall-effects sensor 25 when encountering an episode of contact not exceeding the sensor's operating frequency when the unit is working at maximum RPM (example: unit's maximum RPM 900, sensor frequency range 1 Hz-18 kHz [18,000÷900=20 magnets 18° apart on ¢]). Magnet compositions vary offering distinct characteristics; Neodymium magnets produce the highest amounts of gauss (measurement of the magnetic flux density) but have a lower operating temperature than Samarium Cobalt which produces less. When the magnet composition has been determined the individual magnet arc-segments 12 and 13 are ordered by their inside radius and outside radius equating to their thickness plus their width (length) and the number of arc degrees it occupies (equates to the segments width), when the mounting of the magnets have cured the drive-rotor sub-assembly is brought to finish dimensions on the inside and outside surfaces bearing the magnets by the process of wet grinding to tolerances of ±0.002″ then a 0.0005″ (5 ten thousandth) Ni (nickel) protective coating is applied by electroless plating. The drive-rotor rough casting dimensions are 13.250″OD±0.030″×10.000″ID±0.030″×7.125″W±0.030″ and the finished specifications are: 13.125″OD±0.003″×10.125″ID±0.003″×7.000″W×0.003″ body with recesses for the outer and inner magnet arc-segments 12.750″OD±0.002″ and 10.500″D±0.002″×5.500″W±0.003″ with 6 threaded holes 1.000″±0.005″deep for 0.625″-18(UNF) located on a 11.625″BC spaced 60° on ¢ and 6 location fit holes 0.500″-0.000″-0.002″×0.532″±0.005″deep located on a 11.625″BC spaced 60° on ¢ between the threaded holes. After mounting magnets the OD and ID are wet ground to 13.242″OD±0.002″×10.008″ID±0.002″ the applied the 0.0005″ Ni coating. The specifications for the magnets are: Neodymium magnet Arc-Segments grade N48H that are both identically magnetized through the circumference for both outer and inner segments FIG. 5; 24 outer arc-segments 6.625″OR×6.375″IR×12°×5.500″W and 24 inner arc-segments 5.250″OR×5.000″IR×12°×5.5″W. For the Hall-effects sensor 20 Disc Neodymium magnets 0.750″OD×0.250″W spaced 18° on ¢ located on a 11.625″BC.

The stationary sub-assembly 15 can incorporate a variety of frameless direct drive permanent magnets stators marketed today but most do not use the ideal metal alloy in their mounting backs for efficient heat dissipating when the cooling format is natural convection. MAW-DirectDrives' enhanced cooling stator mounting backs 17 and 21 are casted and made of aluminum bronze conforming to ASTM B148 standards. The stator mounting backs specifications illustrated FIGS. 12, 14, 16 and 18 embodiments are identical. Both inner 21 and outer 17 mounting backs have ribbing casted into their respective rear surfaces 18 and 22 that circumnavigate those said surfaces and are set-in from the front and back edges 1.000″ and to a depth 0.250″ from the front surface, each cooling rib is 0.156″ thick spaced 0.3125″ on ¢ and have a 0.078″ radius on top and between at the bottom. The stator 19 or 23 is centered on the face side with a 0.188″ ledge on each edge. The threaded mounting holes 16.2 and 20.2 are located on the median diameter and machined to a depth of 0.875″ not exceeding 3.000″ spacing on center. The outer mounting back 17 casting is 17.491″OD±0.005″×16.243″ID±0.005″×8.368″W±0.005″ with 18 threaded holes 0.313″-24(UNF) located on a 16.875″BC spaced 20° on ¢. The inner mounting back 21 casting is 6.993″OD±0.005″×5.769ID±0.005″×8.368″W±0.005″ with 8 threaded holes 0.313″-24(UNF) located on a 6.375″BC spaced 45° on ¢.

The stators 19 and 23 are bonded to the enhanced cooling stator mounting backs 17 and 21 and encapsulated in resin then machined and ground to the finished dimensions. The specific wind specification used reflect the intended application but for the illustrated embodiments FIGS. 12, 14, 16 and 18 the outer stator has a 16.243″OD±0.005″×13.258″ID±0.002″×7.981″W±0.005″ and the inner stator has a 6.993″ID±0.005″×9.992″OD×7.981″W±0.005″.

The MAW-DirectDrives basic stationary sub-assembly FIG. 9 is a Precision investment casting made of 4340 alloy steel conforming to ASTM A320 standards. The mounting-plate is cast to the finished dimensions requiring no machining. Wheel-hub casting specifications: length and OD is 0.100″±0.020″ oversize and the ID 0.250″ smaller than the inner tapered roller bearing OD. The casting's wheel-hub is machined inside and out to be concentric and perpendicular to the mounting plate. The unit's threaded hole for the Hall-Effects sensor is centered on the drive-rotor median diameter above the stators' I/O connector accommodation and nearby threaded hole for the thermal sensor. Rough casting specifications: 18.000″OD±0.020″×0.750″W±0.010″ mounting plate with a wheel-hub projecting off 5.600″OD±0.020″×3.750″ID±0.020″×8.500″W±0.020″. The wheel-hub's finish specifications: 5.500″OD±0.010″×8.383″W±0.007″ with a 4.250″ID±0.000″×1.720″D±0.005″ front bore counter-bored 4.329″OD±0.002″×0.283″D±0.005″ and a 4.000″ID±0.000″ rear bore stopping 5.875″±0.005″ from the front. The mounting-plate has 18 counter-bored through holes centered on a 16.875″BC spaced 20° on ¢ for the outer stator mounting-back and 8 counter-bored through holes centered on a 6.375″BC spaced 45° on ¢ for the inner stator mounting-back.

The inner radial shaft seal 6 used in the embodiments illustrated is 4.250″OD×3.465″ID×0.427″W and has an elastomeric OD. The outer radial shaft seal 2 is 4.331″OD×3.898″ID×0.276″W and has an elastomeric OD plus a dust-lip. The XAN Series external retaining ring 8 is 1.670″ID×2.000″OD×0.062″W. The outer taper roller bearing 3 is 4.250″OD×2.000″ID×1.438″W. The inner taper roller bearing is 4.000″OD×1.875″ID×1.375″W. The spacing washer 7 is made of 440A stainless steel 3.000″OD×1.760″ID×0.200″W with identical sized shims 0.001″W, 0.005″W, 0.010″W or 0.025″W.

Some of the many applications for MAW-DirectDrives basic convection cooled units without an outer housing seal are: large centrifugal pumps, heavy machinery presently using frameless direct drive motors benefit, elevators and cranes, any situation needing efficient high torque production especially where space is limited, subways or anything using a large motor to maintain rotation of a flywheel in conjunction with a clutch, present wind turbine generators gain with dual stators able to produce more in practically the same space and etc.

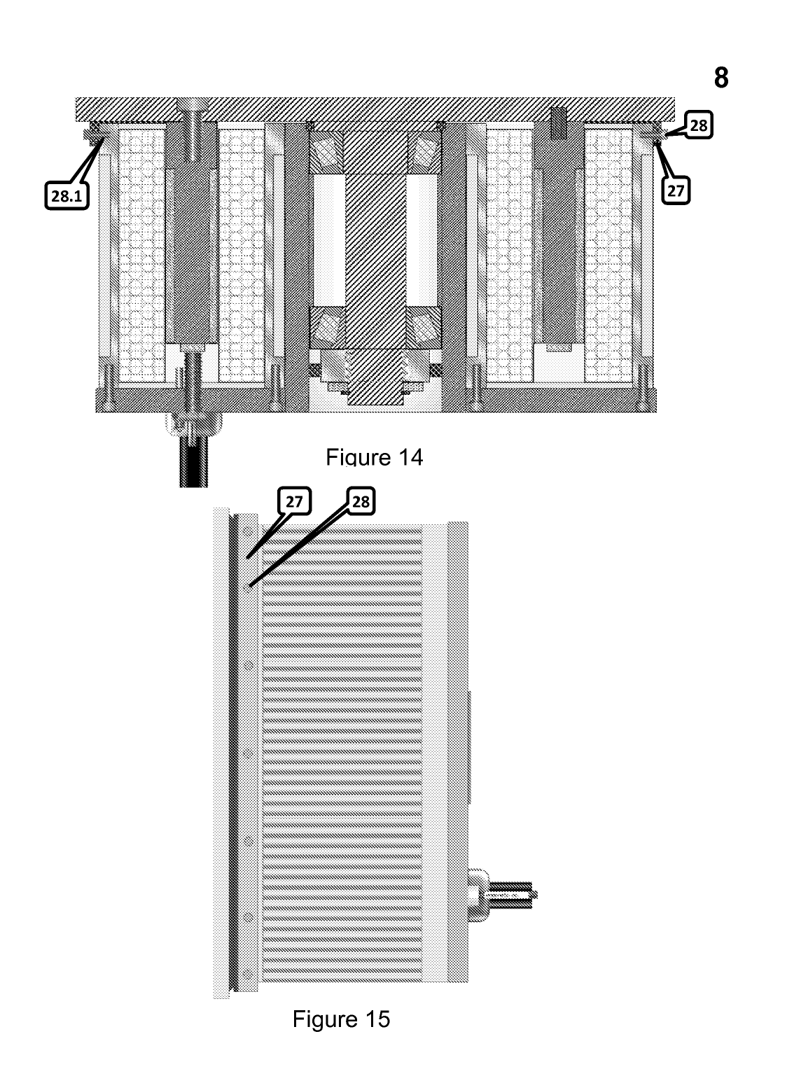

When MAW-DirectDrives need protection from the elements of nature a two-piece outer housing seal and pressure vent 27 FIGS. 1 and 14-17 prevent the entry of outside contaminates and allows access to the seal for maintenance and repair. The seal is adjustable sideways and has a hinging action capable of exerting a specified pressure/force when properly adjusted. A “V” design in the polymer element of the seal that's bonded to a two-piece metal mounting ring has hinging properties. When the internal pressure reaches the specification set for the hinge it allows the pressure to exit between the seal and drive-plate. The hinge allows not only incorporating compressed air-cooling abilities into the housing but regulating the seals ride against the rear face of the drive-plate to extend its lifespan. Having an externally accessible and adjustable two-piece outer housing seal makes for easy service and repair. The annular two piece adjustable external housing seal and pressure vent comprises two elements per piece with each piece being a 179° arc. A metal body casted of 6061 Aluminum has an ID matching the housing OD and is 0.250″H×0.500″W and bonded on its edge is a 0.250″H×0.250″W Teflon V-lip seal calibrated to vent at 15 pounds of internal pressure. Each piece has ten 0.190″ diameter holes elongated 0.125″ for adjustability that match the housing's 20 equally spaced threaded mounting holes around its forward perimeter and the holes in each piece start 8.5° in from the edges equally spaced 18° on ¢.

A compressed air cooled version of MAW-DirectDrives FIGS. 1, 10, 18 and 19 enables the incorporation of stators that offer a more powerful wind that produce a greater power to size ratio but more heat. The compressed air version is better for incorporating neodymium magnets and gain from their greater strength and reduced cost. The compressed air version adds an outer stationary encasement wall 29 to the basic stationary sub-assembly 15 and broadens the wall thickness of the wheel-hub 15.1 to add recessed stator air cooling chambers 30 and 31 into the casting that corresponds in position to the stator's cooling ribs 18 and 22. The casting also incorporates two compressed air inlets into the two chambers 35 and 36 that are threaded 35.1 and 36.1 to accept the input connectors along with their respective inlet holes 37 and 38 into the chambers plus an additional central compressed air inlet connector 34 is positioned between the stators into the mounting-plate 15.2 via a threaded hole 34.1. The compressed air version modifies the stator enhanced cooling mounting backs 17 and 21 by incorporating into their upper backs a groove 31.1 and 33.1 to hold an O-ring 32 and 33 and angled air circulation holes are drilled into their backs 39 and 40 on each side of the cooling ribs 18 and 22 angling toward the 0.188″ ledges on each side of the stators 19 and 23. These modifications allow a sealed cooling area for each stator mounting back via the O-ring connection to the housing and controlling the compressed air travel into the cooling chamber out and around the stator through the center of the unit and out the unit behind the two-piece outer housing seal 27. The overall surface area of the angled air circulation holes for each stator mounting back should not exceed the input line surface area so the pressure can be channeled in the direction you want. The inner stator mounting back allocates 60% of the air volume to the front of the unit to be forced between the inner stator and drive-rotor towards the back for its cooling and then continue on its travel out of the unit. The compressed air cooled version stationary sub-assembly illustrated FIGS. 1, 18 and 19 is a precision investment casting made of 4340 alloy steel conforming to ASTM A320 standards. The casting is casted to the finished dimensions; the outer stationary encasement wall 29 is 18.750″OD±0.007″×17.509ID±0.005″×8.383″W±0.005″ inside and 9.133″W±0.005″ outside overall, the recessed chamber is set-in 0.250″ and inward from the face and back 0.750″. The wheel-hub ID requires no modifications and the exterior is 5.741″OD±0.005″×8.383″W±0.005″ with the recessed chamber set-in 0.188″ mirroring the outer encasement wall. Machining procedures to accommodate the connectors require the mounting-plate 15.2 to have a 0.375″dia. hole centered on an 18.125″BC×2.250″deep with 0.375″NPT to accept the encasement wall coolant connector 35 along with a 0.250″dia. hole centered on a 5.313″BC×2.000″deep with 0.250″NPT to accept the wheel-hub coolant connector 36 when the custom air brake in not utilized. The modifications the stator mounting backs receive require a 0.250″W±0.005″×0.190″deep groove 32.1 and 33.1 set-down from the top 0.250″ on the rear side to accept the 0.250″dia. O-ring and on the face of each mounting back located centered on the ledge extending out from the stators are the air exit holes 39 and 40 that angle back outward towards the ribbing at a 37.5° angle. The outer stator has 18 holes 2.25 mm dia. [12 at the rear spaced 30° on ¢ and 6 at the front spaced 60° on ¢] and the inner stator has 10 holes 2 mm dia. [4 at the rear spaced 90° on ¢ and 6 at the front spaced 60° on ¢].

A liquid and compressed air cooled version of MAW-DirectDrives offers even greater cooling potential using today's state of the art heat transfer fluids FIGS. 11, 16 and 17. The liquid and air cooled version utilizes the same enhanced cooling mounting back as the air cooled version but without the angled air circulation holes. The casting used for the compressed air cooled version is modified by adding a partition wall 30.1 and 31.1 in both internal cooling chambers flush with the surface. Each cooling chamber has an input line on one side of the partition and an output line on the other side that are separated 2.125″ apart centered on the centerline of each partition and positioned across from one-another to create a favorable cluster of input/output lines and connectors FIG. 11. The specifications concerning the coolant inlets connectors 35 and 36 and their accommodations 35.1, 36.1, 37 and 38 outlined for the compressed air cooled version are the same except for the addition of a set of coolant outlets connectors 36.2 and 36.2 and their accommodations 35.3 and 36.3 positioned in relation to the above stated 2.125″ specification.

The MAW-DirectDrives custom air brake FIGS. 19, 20, 21 and 22 requires repositioning the spindle's rear components (taper roller bearing, custom spanner lock nut with spacing washer and shim washers and external retaining ring) forward 4.3 FIG. 3 maintaining their same relationship plus extending the length of the spindle enough to facilitate the travel of the brake rotor. The spindle's end FIG. 22 is configured to accept the ride of the brake rotor using a ball spline format of travel to reduce friction plus increase efficiency and lifespan by milling longitudinal concave grooves 41 FIG. 3 from the spindle's end forward toward the retaining ring which correlate with the brake rotor's ball spline configuration FIG. 21 and then boring the end of the spindle 42.1 to facilitate a die spring. The rotating brake rotor actuates in proportion to the input pressure and kept disengaged by the die spring incorporate into the spindle's end and travels on hardened metal balls 55 positioned in the brake rotor's ball spline locking the parts together. The stationary brake pad 52 is supported by its metal mounting back 53 which is held in place on hardened location pins 54 and possesses a Carbon Kevlar braking surface 52 to act upon the brake rotor's Carbon fiber reinforced ceramic brake surface insert 51. The brake housing 43 incorporates a central air-cylinder 46 with its internal piston 48 riding on a tapered roller thrust bearing 49 set into the brake rotor 50 and is positioned on location pins 54 pressed into the mounting plate rear face and it is also secured by screws 44. The custom air brake housing is a precision investment casting made of aluminum alloy A390.0-T6 conforming to ASTMB618 standards. All interior and exterior dimensions are cast to the finished specifications with a 64μ finish plus all corners and edges have a 0.050″R. The custom air brake housing is cast maintaining a 0.375″WTh throughout with a 8.750″OD±0.005″×0.375″W±0.005″ mounting ring with 10 through holes 0.250″dia. centered on a 8.250″BC spaced 36° on ¢ at the base of a 7.750″OD±0.005″×2.000″H±0.005″ brake cover with a 2.000″OD±0.005″×1.625″H±0.005″ air cylinder cover centered on its top machined with a 0.250″NPT hole to accept the air inlet connector 47. The brake rotor casting is a plaster cast made of phosphor bronze conforming to ASTM B139/B139M-07 standards. Rough casting dimensions for the brake rotor are 7.000″OD±0.030″×0.900″W±0.030″ disc with a 2.750″OD±,030″×2.000″W±0.030″ boss at center. Brake rotor finish specifications are 6.750″OD±0.010″×0.750″W±0.010″ disc with a 2.500″OD±0.010″×2.000″W±0.010″ boss that has 6 drilled and bottom reamed holes 0.250″dia.±0.000″×1.630″±0.002″deep located on a 1.875″BC spaced 60° apart on ¢ for the hardened metal balls 55 and a 1.813″ID±0.002″×2.000″±0.010″deep bore at center that has a 2.000″ID±0.005″×0.375″±0.002″deep counter-bore grooved in at the bottom of the counter-bore to 2.166″ID×0.160″W for an internal retaining ring 56 then the inside face is recessed in 2.000″W±0.010″×0.250″±0.010″deep for the Carbon fiber reinforced ceramic brake rotor insert 51 and the outside face is bored for the tapered roller thrust bearing 1.109″ID±0.005″×0.406″±0.005″deep. The Carbon Kevlar annular brake pad 52 is 6.750″OD±0.010″×2.750″ID±0.005″×0.250″W±0.005″ and its identical sized metal mounting back 53 has 6 location fit holes 0.375″ID−0.000″+0.002″ on a 5.000″BC spaced 60° on ¢ for the hardened location pins 54. The air cylinder comprises a hardened metal pressed in bushing 46 that is 1.250″OD±0.001″×1.004″ID±0.001″×1.625″W±0.005″ that a plunger 48 made of air-hardening drill rod 1.000″OD±0.000″×1.656″W±0.005″ machined with a 0.065″W±0.002″×0.055″±0.002″deep groove 0.375″ from the rear for an O-ring. The die spring used within the spindle is 1.000″OD×2.500″W made with 0.100″×0.215″ wire having a load range of 200-250 Lbs . . . .

What is claimed is:

1. A mechanical direct drive mounting apparatus enabling the incorporation of paired prefabricated frameless direct drive permanent magnets brushless motor stators as actuators to induce rotation of a wheel and axel about a stationary sub-assembly's wheel-hub comprising:
a. a stationary sub-assembly wherein a central cylindrical wheel-hub projecting forward from a circular mounting-plate comprises machined inside diameters to accept inner and outer taper roller bearings and radial shaft seals and said circular mounting-plate comprises two concentric sets of counter-bored through-holes for securing inner and outer enhanced cooling stator mounting backs holding the aforementioned prefabricated stators plus machined to accept between said stators an opening for the stators' input/output connector plus holes for a thermal sensor and digital speed and direction sensor in addition to preconfigured accommodations via its back for mounting to vehicle suspensions or stationary objects,
b. a drive-plate and spindle sub-assembly wherein a machined solid spindle projecting back from a circular drive-plate boss joins both sub-assemblies and comprises machined outside diameters for inner and outer taper roller bearings and radial shaft seals plus screw threads and a groove behind the inner taper roller bearing for a custom lock nut, spacing washer and external retaining ring and said drive-plate is machined with preconfigured accommodations via its face for mounting to vehicle wheels or objects requiring rotation and a set of concentric counter-bored through-holes for securing a drive-rotor with a like diameter set on the inside of bored press fit location holes bearing hardened location pins to locate and maintain concentricity of said drive-rotor,
c. a cylindrical two-sided permanent magnets drive-rotor connected inside a drive-plate and spindle sub-assembly concentrically disposed proximate to the stators' core peripheral surfaces, wherein predetermined numbers of permanent magnets arc-segments disposed evenly spaced on the inside and outside surfaces separated from the stators by a predetermined gap distance, such that relative motion of the drive-rotor between fixed stators causes magnetic flux from the magnets to interact with and induce current in the stator winding and/or interact with an electrified stator winding to induce rotation of said drive-plate and spindle sub-assembly about the axis of the stationary sub-assembly's wheel-hub comprises a predetermined size cylindrical shaped metal casting machined with two rabbeted lands at the end on the inside and outside an equidistance in size to the predetermined size rare earth magnet arc-segments comprising the two-sided permanent magnets drive-rotor wherein the remaining breadth of the casting between said inner and outer magnet arc-segments are sufficient to perform the predetermined workload capacity, wherein the casting's front face has a predetermined number of location fit holes bored on the casting's median diameter replicating the layout implemented on the drive-plate in addition to an identical number of threaded mounting holes mating to the drive-plate's set of counter-bored through-holes in addition the casting's rear face has a predetermined number and size of Neodymium disc magnets bonded equally spaced on the casting's median diameter to interact with a Hall effects digital speed and direction sensor entering from the stationary mounting-plate.

2. The mechanical direct drive mounting apparatus of claim 1, wherein a custom lock nut comprises:
A predetermined size hard metal three dimensional annulus machined on the inside diameter with mating threads to the spindle having a surface finish on the outside diameter for an inner radial shaft seal's ride and an even number of bored holes equally spaced on the back positioned to accommodate tightening with a spanner wrench.

3. The mechanical direct drive mounting apparatus of claim 1, wherein two facing enhanced cooling stator mounting backs each comprise:
A predetermined size cylindrical shaped metal casting configured with inset cooling ribs that circumnavigate the back equally spaced an equidistance permitting a space between equal to the rib's thickness wherein all ribs and valleys terminate with a radius equal to half a rib's thickness and reside a predetermined distance in from the sides, wherein the rear edge has a predetermined number of threaded mounting holes on a bolt circle equating to the casting's median diameter to a depth not infringing into the cooling ribs, wherein the casting's predetermined length permits predetermined size ledges to extend out beyond the mounted stator.

4. The mechanical direct drive mounting apparatus of claim 1, wherein enclosing said unit to augment cooling the stators with compressed air comprises:
Incorporating a predetermined size outer stationary encasement wall onto the stationary sub-assembly mounting plate that projects out an equidistance to the enhanced cooling mounting backs and broaden the breadth of the wheel-hub to facilitate adding two predetermined size recessed stator air cooling chambers into the casting that corresponds in position to the inner and outer stator mounting back's cooling ribs, wherein the casting incorporates two compressed air inlets into the chambers via holes having threads in the mounting back and an additional threaded through-hole near the cluster of input/output connectors for a compressed air input connector, wherein both internal diameters are set to allow a specified gap between the encasement wall and wheel-hub to the outer and inner stator mounting backs to facilitate incorporating an O-ring into the upper rear of both stator mounting backs via machining in a corresponding groove that said O-rings create sealed environments behind each stator for directing air flow in and about and out via angled air circulation/outlet holes drilled on each side of the cooling ribs exiting out both ledges extending from the stators,

5. The mechanical direct drive mounting apparatus of claim 1, wherein enclosing said unit to augment cooling the stators with liquid and compressed air comprises:
Incorporating a predetermined size outer stationary encasement wall onto the stationary sub-assembly mounting plate that projects out an equidistance to the enhanced cooling mounting backs and broaden the breadth of the wheel-hub to facilitate adding two predetermined size recessed stator air cooling chambers into the casting that corresponds in position to the inner and outer stator mounting back's cooling ribs that have partition walls from front to back flush with the surface, wherein the casting incorporates two fluid inlets on one side of each partition and two fluid outputs on the other side into the chambers via holes having threads in the mounting back and an additional threaded through-hole near the cluster of input/output connectors for a fluid input connector, wherein both internal diameters are set to allow a specified gap between the encasement wall and wheel-hub to the outer and inner stator mounting backs to facilitate incorporating an O-ring into the upper rear of both stator mounting backs via machining in a corresponding groove that said O-rings create sealed environments behind each stator for directing fluid in, around and return back.

6. The mechanical direct drive mounting apparatus of claim 1, wherein an optional supplemental two-piece outer seal comprises:
A split three dimensional annular aluminum casting with an ID equaling the stationary exterior surface OD wherein each piece has a predetermined number of elongated holes centered in the length of its body equally spaced on center mating to threaded mounting holes machined in the exterior surface around the outer front perimeter, wherein each piece has a same height Teflon V-lip seal designed to flex at the vertex to enable adjustability bonded on its front edge.

7. The mechanical direct drive mounting apparatus of claim 1, wherein a custom air brake configured for the unit comprises:
a. Lengthening the spindle's OD land behind the external retaining ring a predetermined amount and boring a predetermined size hole into the end to accommodate a die spring plus machine in a predetermined number of longitudinal concave grooves a predetermined depth and to a predetermined location behind the retaining ring to facilitate the locking and travel of the brake rotor with its incorporated ball spline,
b. An oversize brake rotor casting machined to a predetermined finish configuration comprising; a predetermined sized bored hole centered on the outer face for a sealed taper roller thrust bearing; a predetermined size rabbet on the outer rear face of the brake rotor for bonding a Carbon fiber reinforced ceramic brake rotor insert; a predetermined size boss protruding off the center of the rear face with a predetermined number of bored and bottom reamed holes evenly spaced centered on a diameter facilitating their intrusion into the longitudinal concave grooves machined into the spindle and a predetermined size inside diameter facilitating the spindle's unobstructed travel within, bored to a predetermined depth that is counter bored a predetermined diameter and depth and grooved at the bottom of the counter-bore to accept an internal retaining ring for retaining a predetermined number of hardened metal balls residing in the bored and bottom reamed holes,
c. An annular shaped brake pad comprising; a predetermined size metal mounting back mirroring the brake rotor insert diameters is supported by a predetermined number of location fit holes within, on a matching number of location pins pressed into corresponding press fit holes in the mounting plate; a bonded like sized Carbon Kevlar brake pad interacts with the brake rotor's carbon fiber reinforced ceramic insert,
d. A predetermined sized brake housing maintaining a common wall thickness throughout comprises; an annular shaped mounting ring with a predetermined number of through-holes mating to threaded holes in the stationary mounting-plate connects via machine screws and the brake housing locates on a predetermined number of location pins pressed into bored press fit holes machined into the stationary mounting plate; a predetermined sized housing coming off the mounting ring maintains sufficient clearance inside for all components to operate unobstructed and has on top at center an air cylinder covering with a threaded air input hole and connector centered on top for feeding compressed air into a predetermined size brake cylinder that has a pressed in hardened metal sleeve and a predetermined sized hardened metal brake cylinder plunger applying pressure on the tapered roller thrust bearing in proportion to the input pressure and otherwise kept disengaged by the incorporated die spring in the spindle.
